(19) United States
(12) Patent Application Publication
(10) Pub. No.: US 2011/0305048 A1
(43) Pub. Date: Dec. 15, 2011

(54) ACTIVE-CLAMP CIRCUIT FOR QUASI-RESONANT FLYBACK POWER CONVERTER

(75) Inventors: TA-YUNG YANG, MILPITAS, CA (US); YING-CHIEH SU, TAIPEI COUNTY (TW); CHAO-CHIH LIN, TAOYUAN COUNTY (TW)

(73) Assignee: SYSTEM GENERAL CORP., TAIPEI HSIEN (TW)

(21) Appl. No.: 13/086,588

(22) Filed: Apr. 14, 2011

Related U.S. Application Data
(60) Provisional application No. 61/353,771, filed on Jun. 11, 2010.

(51) Int. Cl. H02M 3/335

(52) U.S. Cl. 363/21.03

(57) ABSTRACT

An active clamp circuit for a QR flyback power converter according to the present invention comprises an active-clamper connected to a primary winding of a power transformer of the QR flyback power converter in parallel. A high-side transistor driver is coupled to drive the active-damper. A charge-pump circuit is coupled to the high-side transistor driver to provide a power supply to the high-side transistor driver in accordance with a voltage source. A control circuit generates a control signal coupled to control the high-side transistor driver. The control signal is generated in response to a PWM signal and an input voltage of the QR flyback power converter.

### REFERENCE TO RELATED APPLICATION

This Application is based on Provisional Patent Application Ser. No. 61/353,771, filed 11 Jun. 2010, currently pending.

### BACKGROUND OF THE INVENTION

1. Field of the Invention

The present invention relates to power converters, and more particularly, relates to the soft switching power converters.

2. Description of the Related Art

Flyback power converters have been widely used to provide power supplies for electronic products, such as home appliances, computers, battery charger etc. For achieving higher efficiency and reducing power loss, the power converter can be designed to operate at the quasi-resonant (QR) switching when the power converter is operated at high input voltage and high switching frequency. The QR switching is preferred for reducing the switching losses and EMI. The present invention is an active-clamp circuit for the quasi-resonant (QR) flyback power converter. The objective of this invention is to improve the efficiency of the QR flyback power converter by recycling the stored energy of the leakage inductor of the power transformer of the QR flyback power converter and achieving the quasi-resonant soft-switching operation. Therefore, the QR flyback power converter can be operated at higher switching frequency for reducing the size of its power transformer. The related prior arts can be found in “Clamped Continuous Flyback Power Converter”, U.S. Pat. No. 5,570,278 and “Offset Resonance Zero Voltage Switching Flyback Converter” U.S. Pat. No. 6,069,803.

### BRIEF SUMMARY OF THE INVENTION

It is an objective of the present invention to provide an active-clamp circuit for a quasi-resonant (QR) flyback power converter. It can recycle the stored energy of the leakage inductor of the power transformer of the QR flyback power converter and achieve the quasi-resonant soft-switching operation for improving the efficiency of the QR flyback power converter.

It is an objective of the present invention to provide an active-clamp circuit for a QR flyback power converter. It can make the QR flyback power converter being operated at higher switching frequency for reducing the size of its power transformer.

The active-clamp circuit for the QR flyback power converter according to the present invention comprises an active-clamper, a high-side transistor driver, a charge-pump circuit and a control circuit. The active-damper is connected to a primary winding of a power transformer of the QR flyback power converter in parallel. The high-side transistor driver is coupled to drive the active-damper. The charge-pump circuit is coupled to the high-side transistor driver to provide a power supply to the high-side transistor driver in accordance with a voltage source. The control circuit generates a control signal coupled to control the high-side transistor driver. The control signal is generated in response to a PWM signal and an input voltage of the QR flyback power converter.

### BRIEF DESCRIPTION OF THE DRAWINGS

The invention can be more fully understood by reading the subsequent detailed description and examples with references made to the accompanying drawings, wherein:

FIG. 1 shows a circuit diagram of a preferred embodiment of a QR flyback power converter according to the present invention.

FIG. 2A˜FIG. 2E show the circuit operations of the QR flyback power converter according to the present invention.

FIG. 3 shows the key waveforms of the QR flyback power converter including the PWM signal, the control signal and the high voltage signal according to the present invention.

FIG. 4 shows a circuit diagram of a preferred embodiment of the PWM controller according to the present invention.

FIG. 5 shows a circuit diagram of a preferred embodiment of the control circuit according to the present invention.

### DETAILED DESCRIPTION OF THE INVENTION

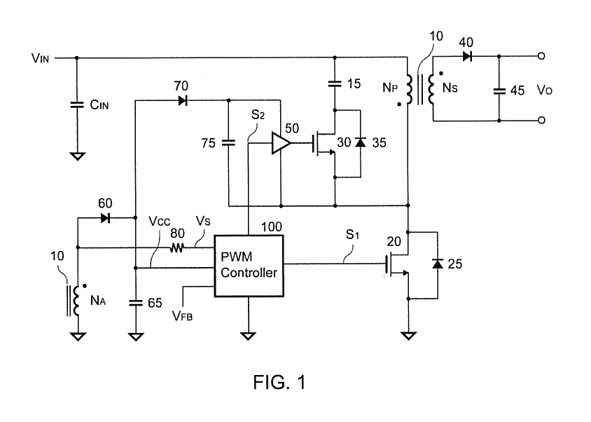

FIG. 1 is a circuit diagram of a preferred embodiment of a QR flyback power converter according to the present invention. The QR flyback power converter includes a power transformer 10 having a primary winding N_{P} in the primary side and a secondary winding N_{S} in the secondary side. A first terminal of the primary winding N_{P} is coupled to one terminal of an input capacitor C_{IN} and receives an input voltage V_{IN}. The other terminal of the input capacitor C_{IN} is further coupled to a ground. A main-power transistor 20 is coupled to switch the primary winding N_{P} of the power transformer 10 for regulating an output voltage V_{O} at the output of the QR flyback power converter through a rectifier 40 and an output capacitor 45. A drain terminal of the main-power transistor 20 is coupled to a second terminal of the primary winding N_{P} of the power transformer 10. A source terminal of the main-power transistor 20 is coupled to the ground. An anode of the rectifier 40 is coupled to one terminal of the secondary winding N_{S}. The output capacitor 45 is coupled between a cathode of the rectifier 40 and the other terminal of the secondary winding N_{S}. The output capacitor 45 is further coupled to the output of the QR flyback power converter in parallel.

A parasitic diode 25 is a body diode that is coupled to the main-power transistor 20 in parallel. A PWM controller 100 generates a PWM signal S₁ coupled to a gate terminal of the main-power transistor 20 to drive the main-power transistor 20. That is, the PWM signal S₁ is coupled to control the main-power transistor 20 of the QR flyback power converter for the regulation. The PWM signal S₁ is generated in accordance with a feedback signal V_{FB}. The feedback signal V_{FB} is coupled to the output of the QR flyback power converter and correlated to the output voltage V_{O}. The power transformer 10 further includes an auxiliary winding N_{A} for generating a voltage source V_{CC} via a rectifier 60 and a capacitor 65. An anode of the rectifier 60 is coupled to a first terminal of the auxiliary winding N_{A}. A second terminal of the auxiliary winding N_{A} is coupled to the ground. One terminal of the capacitor 65 is coupled to a cathode of the rectifier 60 and the PWM controller 100. The other terminal of the capacitor 65 is coupled to the ground. The voltage source V_{CC} is further connected to supply the power to the PWM controller 100.

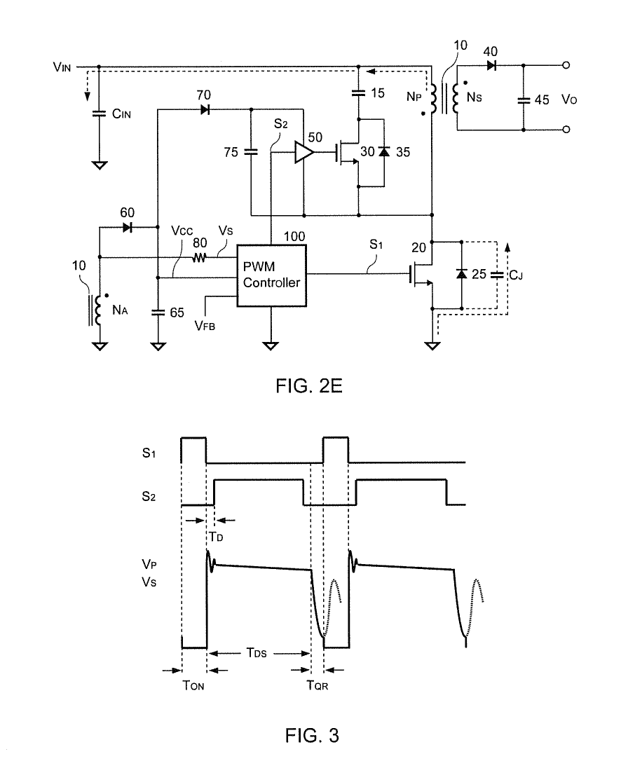

A resistor 80 is coupled from the first terminal of the auxiliary winding N_{A} of the power transformer 10 to the PWM controller 100 for generating a sense signal V_{S} at the PWM controller 100. An active clamp circuit comprises an active-clamper, a high-side transistor driver 50, a charge-pump circuit and a control circuit (LPC) 200 (shown in FIG. 4) of the PWM controller 100. A power transistor 30 is connected to a capacitor 15 in series to develop the active-clamper. The active-clamper is connected to the primary winding N_{P} of the power transformer 10 in parallel. One terminal of the capacitor 15 is coupled to the first terminal of the primary winding N_{P}, and the other terminal of the capacitor 15 is coupled to a drain terminal of the power transistor 30. A source terminal of the power transistor 30 is coupled to the second terminal of the primary winding N_{P} and the drain terminal of the main-power transistor 20.

A parasitic diode 35 is a body diode that is coupled to the power transistor 30 in parallel. The high-side transistor driver 50 is coupled to a gate terminal of the power transistor 30 to drive the power transistor 30 of the active-clamper. Thus, the high-side transistor driver 50 is used to drive the active-damper. The charge-pump circuit is coupled to the high-side transistor driver 50 to provide a power supply to the high-side transistor driver 50 in accordance with the voltage source V_{CC}. The charge-pump circuit is developed by a diode 70 coupled to the voltage source V_{CC} and a charge-pump capacitor 75 coupled to the diode 70 in series. The charge-pump capacitor 75 is further coupled to the high-side transistor driver 50 in parallel. The PWM controller 100 generates a control signal S₂ coupled to control the high-side transistor driver 50. The control signal S₂ is generated in response to the PWM signal S₁ and the sense signal V_{S}. The control signal S₂ can be turned on once the PWM signal S₁ is turned off. The sense signal V_{S} is correlated to the input voltage V_{IN} of the power converter. The pulse width of the control signal S₂ is generated in response the pulse width of the PWM signal S₁ and the amplitude of the input voltage V_{IN}.

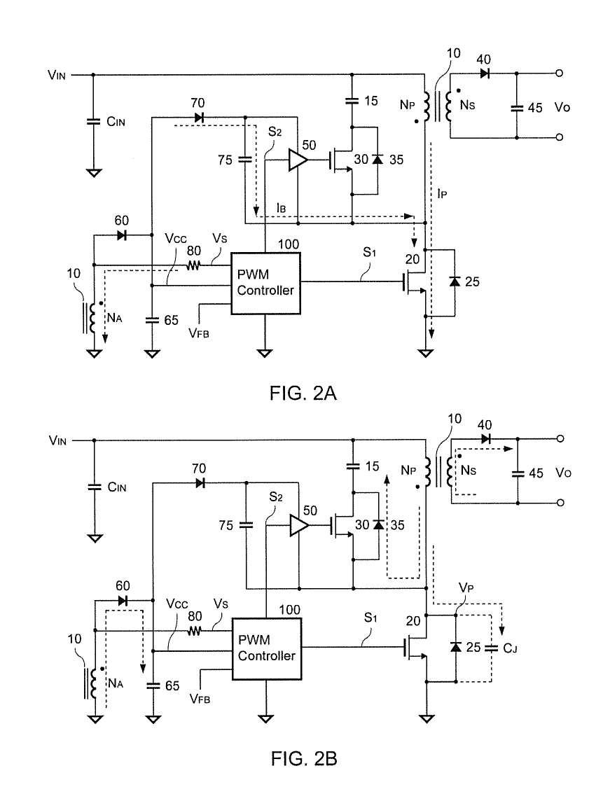

From FIG. 2A to FIG. 2E shows the circuit operations of the QR flyback power converter according to the present invention. FIG. 2A shows that the main-power transistor 20 is turned on and the power transistor 30 is turned off, that is to say, the control signal S₂ is off-state and the PWM signal S₁ is on-state. When the main-power transistor 20 is turned on, the input voltage V_{IN} will be added across the primary winding N_{P} of the power transformer 10 and a switching current I_{P} will flow through the main-power transistor 20. A voltage V_{NA} is generated at the auxiliary winding N_{A} of the power transformer 10, and the voltage V_{NA} is coupled to the PWM controller 100 through the resistor 80 for generating the sense signal V_{S}. The amplitude of the voltage V_{NA} is correlated to the amplitude of the input voltage V_{IN} and the turn ratio N_{A}/N_{P} of the power transformer 10. Furthermore, the charge-pump capacitor 75 is charged by the voltage source V_{CC} through the diode 70.

FIG. 2B shows the main-power transistor 20 is turned off and the PWM signal S₁ is off-state. When the main-power transistor 20 is turned off and the PWM signal S₁ is off-state, the energy stored in the power transformer 10 will be transferred to the secondary winding N_{S} of the power transformer 10 to generate the output voltage V_{O} at the output of the QR flyback power converter, and it will be also transferred to the auxiliary winding N_{A} to charge the capacitor 65 for the voltage source V_{CC} via the rectifier 60. Meanwhile, the energy stored in the magnetized inductor and leakage inductor of the primary winding N_{P} will be delivered to a parasitic capacitor C_{J} of the main-power transistor 20 and the capacitor 15 through the parasitic diode 35 of the power transistor 30. The parasitic capacitor C_{J} is coupled to the main-power transistor 20 in parallel.

FIG. 2C shows that once the parasitic diode 35 is forward-bias, the control signal S₂ will be enabled to turn on the power transistor 30 through the high-side transistor driver 50. The energy stored in the capacitor 15 is thus able to deliver to the output voltage V_{O} through the power transformer 10. FIG. 2D and FIG. 2E show that the power transistor 30 is turned off and the control signal S₂ is off-state. FIG. 2D and FIG. 2E also show the quasi resonant operation. The energy stored in the parasitic capacitor C_{J} of the main-power transistor 20 will be charged to the magnetized inductor of the primary winding N_{P} of the power transformer 10. After that, the energy stored in the magnetized inductor of the primary winding N_{P} of the power transformer 10 will be delivered to discharge the parasitic capacitor C_{J} of the main-power transistor 20. Once the parasitic capacitor C_{J} of the main-power transistor 20 is discharged to a lower voltage, the PWM signal S₁ is enabled to turn on the main-power transistor 20 for soft-switching operation. The detail description can be found in the prior art of “Power converter having phase lock circuit for quasi-resonant soft switching”, U.S. Pat. No. 7,466,569.

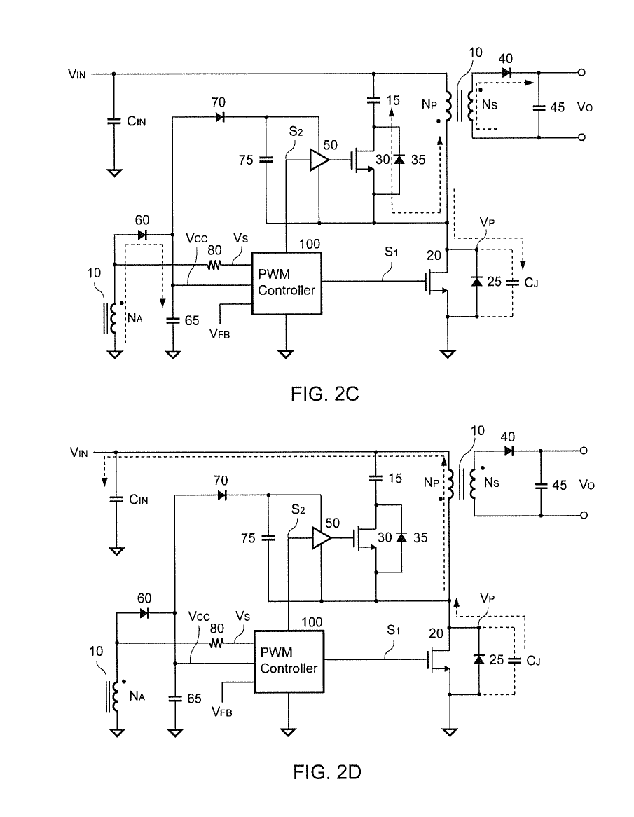

FIG. 3 shows the key waveforms of the QR flyback power converter including the PWM signal S₁, the control signal S₂ and a high voltage signal V_{P} (shown in FIG. 2B) according to the present invention. The waveform of the sense signal V_{S} is correlated to the waveform of the high voltage signal V_{P} at the drain terminal of the main-power transistor 20. The PWM signal S₁ is coupled to control the main-power transistor 20 (shown in FIG. 1) of the QR flyback power converter for the regulation. The main-power transistor 20 is coupled to switch the primary winding N_{P} of the power transformer 10. The pulse width of the PWM signal S₁ is an on-time T_{ON}. The control signal S₂ is generated after a delay time T_{D} when the PWM signal S₁ is turned off. The pulse width of the control signal S₂ is shorter than the demagnetization time T_{DS} of the power transformer 10. Therefore, the control signal S₂ is turned off before the power transformer 10 is fully demagnetized. The quasi-resonant time T_{QR} shows the quasi-resonant period of the high voltage signal V_{P}. The PWM signal S₁ is turned on during a valley voltage of the high voltage signal V_{P} for reducing the switching loss of the main-power transistor 20.

FIG. 4 is a circuit diagram of a preferred embodiment of the PWM controller 100 according to the present invention. The PWM controller 100 includes a PWM circuit (PWM) 150 and the control circuit (LPC) 200. The control circuit 200 is a linear-predict circuit that receives the PWM signal S₁ and the sense signal V_{S} and generates the control signal S₂ in accordance with the pulse width of the PWM signal S₁ and the amplitude of the sense signal V_{S}. The control signal S₂ is coupled to control the high-side transistor driver 50 for turning on/off the power transistor 30. The sense signal V_{S} is correlated to the input voltage V_{IN} of the power converter. The pulse width of the control signal S₂ is proportional to the pulse width of the PWM signal S₁ and the amplitude of the input voltage V_{IN}. In other words, the pulse width of the control signal S₂ is generated in response to the pulse width of the PWM signal S₁ and the amplitude of the input voltage V_{IN}. The PWM circuit 150 receives the feedback signal V_{FB} and the sense signal V_{S} and generates the PWM signal S₁ in response to the feedback signal V_{FB} and the sense signal V_{S}. The description of the PWM circuit 150 can be found in the prior-art of “Switching control circuit for primary-side controlled power converters”, U.S. Pat. No. 7,362,592, so here is no detailed description about it.

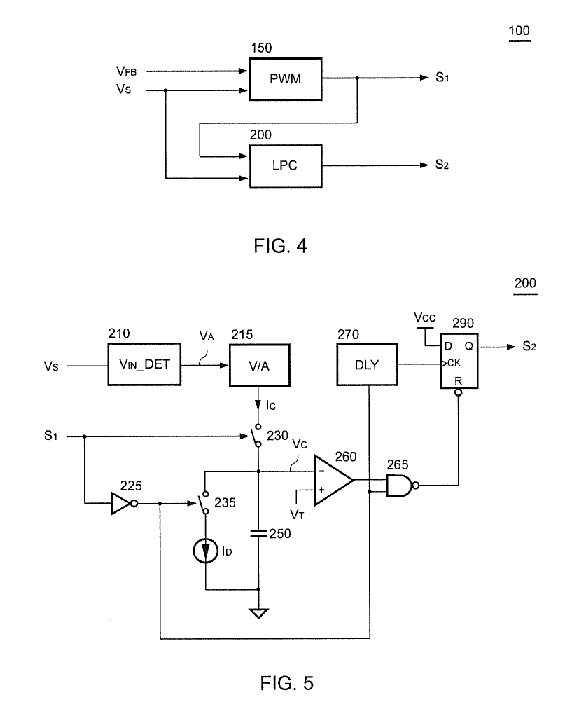

FIG. 5 is a circuit diagram of a preferred embodiment of the control circuit 200 according to the present invention. The control circuit 200 includes an input voltage-detection circuit (V_{IN}_{_{—}}DET) 210 coupled to receive the sense signal V_{S} for generating a voltage signal V_{A}. The description and the detail operation of the input voltage-detection circuit 210 can be found in the prior art of “Detection circuit for sensing the input voltage of transformer”, U.S. Pat. No. 7,671,578. A voltage-to-current converter (V/A) 215 receives the voltage signal V_{A} to generate a charge current I_{C}. The charge current I_{C} is utilized to charge a capacitor 250 via a switch 230 for generating a charge signal V_{C} when the PWM signal S₁ is on-state. The switch 230 is coupled between the voltage-to-current converter 215 and the capacitor 250. The capacitor 250 is further coupled to the ground.

A discharge current I_{D} is coupled to discharge the capacitor 250 via a switch 235 when the PWM signal S₁ is off-state. The switch 235 is coupled between the discharge current I_{D} and the capacitor 250. The discharge current I_{D} is further coupled to the ground. The PWM signal S₁ is coupled to control the on/off status of the switch 230, and the PWM signal S₁ is coupled to control the on/off status of the switch 235 through an inverter 225. Through the inverter 225 and a time-delay circuit (DLY) 270, the PWM signal S₁ is coupled to a clock input CK of a flip-flop 290. Therefore, the flip-flop 290 will generate the control signal S₂ at an output Q of the flip-flop 290 after the delay time T_{D} (shown in FIG. 3) when the PWM signal S₁ is turned off. An output of the inverter 225 is coupled to the time-delay circuit 270. The time-delay circuit 270 is coupled to the clock input CK of the flip-flop 290. An input D of the flip-flop 290 is supplied with the voltage source V_{CC}.

A threshold voltage V_{T} is supplied with a positive input of a comparator 260. A negative input of the comparator 260 is coupled to the switches 230, 235 and the capacitor 250 for receiving the charge signal V_{C} at the capacitor 250 to compare with the threshold voltage V_{T}. A first input of an NAND gate 265 is coupled to an output of the comparator 260. A second input of the NAND gate 265 is coupled to the time-delay circuit 270 and the output of the inverter 225. An output of the NAND gate 265 is connected to a reset input R of the flip-flop 290 to reset the flip-flop 290 for switching off the control signal S₂ when the charge signal V_{C} is lower than the threshold voltage V_{T}. It is to say, the control signal S₂ is switched off before the power transformer 10 (shown in FIG. 1) is full demagnetized.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active clamp circuit for a QR flyback power converter, comprising:
an active-damper connected to a primary winding of a power transformer of the QR flyback power converter in parallel;
a high-side transistor driver coupled to drive the active-clamper;
a charge-pump circuit coupled to the high-side transistor driver to provide a power supply to the high-side transistor driver in accordance with a voltage source; and
a control circuit generating a control signal coupled to control the high-side transistor driver;
wherein the control signal is generated in response to a PWM signal and an input voltage of the QR flyback power converter.

2. The active clamp circuit as claimed in claim 1, wherein the active-clamper comprises:
a capacitor coupled to a first terminal of the primary winding of the power transformer; and
a power transistor coupled to a second terminal of the primary winding of the power transformer and connected to the capacitor in series.

3. The active clamp circuit as claimed in claim 1, wherein the PWM signal is coupled to control a main-power transistor of the QR flyback power converter for the regulation; the main-power transistor is coupled to switch the primary winding of the power transformer.

4. The active clamp circuit as claimed in claim 1, wherein the control signal is turned on once the PWM signal is turned off.

5. The active clamp circuit as claimed in claim 1, wherein the pulse width of the control signal is generated in response to the pulse width of the PWM signal and the amplitude of the input voltage.

6. The active clamp circuit as claimed in claim 1, wherein the charge-pump circuit comprises:
a diode coupled to the voltage source; and
a charge-pump capacitor coupled to the diode in series;
wherein the charge-pump capacitor is connected to the high-side transistor driver.

7. The active clamp circuit as claimed in claim 1, wherein the control circuit is a linear-predict circuit that generates the control signal in accordance with the pulse width of the PWM signal and the amplitude of the input voltage; the pulse width of the control signal is proportional to the pulse width of the PWM signal and the amplitude of the input voltage.

8. The active clamp circuit as claimed in claim 1, wherein the control signal is turned off before the power transformer is fully demagnetized.

9. The active clamp circuit as claimed in claim 1, wherein the voltage source is generated by an auxiliary winding of the power transformer.

10. The active clamp circuit as claimed in claim 1, wherein the control signal is generated after a delay time when the PWM signal is turned off.

11. The active clamp circuit as claimed in claim 1, wherein the control circuit comprises:
an input voltage-detection circuit coupled to receive a sense signal for generating a voltage signal, in which the sense signal is correlated to a high voltage signal of a main-power transistor of the QR flyback power converter, the main-power transistor is coupled to switch the primary winding of the power transformer;
a voltage-to-current converter receiving the voltage signal to generate a charge current;
a capacitor charged by the charge current for generating a charge signal when the PWM signal is on-state;
a discharge current discharging the capacitor when the PWM signal is off-state; and
a comparator receiving the charge signal to compare with a threshold voltage for switching off the control signal when the charge signal is lower than the threshold voltage.
